(19) United States
(12) Patent Application Publication
(10) Pub. No.: US 2006/0234116 A1
(43) Pub. Date: Oct. 19, 2006

(54) External hybridisation

(75) Inventors: Jens Müller, Munchen (DE); Oliver Freitag, Munich (DE)

Correspondence Address: IP STRATEGIES, 12 1/2 WALL STREET, SUITE I, ASHEVILLE, NC, 28801, US

(73) Assignee: SFC Smart Fuel Cell AG, Brunnthal-Nord (DE)

(21) Appl. No.: 10/529,119

(22) PCT Filed: Jun. 3, 2003
(86) PCT No.: PCT/EP03/05794

§ 371 Date: Mar. 3, 2006

(30) Foreign Application Priority Data
Sep. 25, 2002 (EP) 02021762.6

(51) Int. Cl. H01M 2/10

(52) U.S. Cl. 429/123

(57) ABSTRACT

The invention relates to a connection device for an electrical consumer which is provided with an internal energy source so that, when an external energy source is connected, the internal energy source and the external energy source form a hybrid energy source. The connection device comprises an interconnection designed in such a way that an external energy source connected to the connection device (i) exclusively supplies the consumer with energy in a lower load range and (ii) in a higher load range supplies the consumer with energy in conjunction with the internal energy source. The invention also relates to an interface or an electrical consumer having such a connection device.

### FIELD OF THE INVENTION

The invention relates to a connection device for an electrical consumer which is provided with an internal energy source so that, when an external energy source is connected, the internal energy source and the external energy source form a hybrid energy source. The connection device comprises an interconnection designed in such a way that an external energy source connected to the connection device (i) exclusively supplies the consumer with energy in a lower load range and (ii) in a higher load range supplies the consumer with energy in conjunction with the internal energy source. The invention also relates to an interface or an electrical consumer having such a connection device.

### THE PRIOR ART

Consumers which are designed for battery and mains operation can frequently be operated with disposable batteries (primary elements) or rechargeable accumulators (secondary elements), one and the same mounting place being used as a rule to accommodate them. Since it is necessary to avoid charging up the internal energy source (battery) in this case, the interface to the mains connection is usually so designed that in mains operation only the consumer is supplied with current/voltage and the battery is decoupled from the consumer circuit. The best known examples of this are larger items of portable equipment employed in the field of audio entertainment electronics, e.g. so-called ghetto blasters.

Numerous consumers, on the other hand, have an integrated accumulator as their internal energy source and are additionally provided with an interface for connecting an external energy source so designed that the consumer can be operated via the external energy source while at the same time the internal energy source can be charged up via the connected external energy source. Examples of this are most of the common mobile telephone and laptop models, in which the integrated accumulator cannot normally be replaced by commercial disposable batteries.

In the cases quoted above the mains usually constitutes the external energy source, the desired voltage being obtained from the mains voltage by means of a power pack, usually external for smaller devices and internal for larger devices.

Compared with supplying energy from the mains, alternative energy sources such as solar cells and fuel cells exhibit many advantages, especially of course that of being independent of the mains. However, the cited alternative energy sources, in which energy is generated on the basis of surface processes, are just the ones for which the cost of manufacture is strongly dependent on the output capacity and thus on the size of the energy source.

Thus, even when the time-averaged energy consumption of electrical consumers could easily be covered by solar cells, fuel cells, etc., their use often becomes uneconomical because they would have to be greatly over-dimensioned if they must also cope on their own with occasional, abnormally high consumer load peaks or possess sufficient extra capacity to charge up an internal energy source at the same time as operating the consumer.

For example, a laptop power pack which simultaneously charges the laptop accumulator and operates the laptop must supply about 75 W even if laptop operation alone accounts for only about 20 W.

For power packs these differences have so little impact on the cost of manufacture that a larger-dimensioned power pack is still more economical than other, at first sight, better solutions. If, on the other hand, a fuel cell system e.g. serves as the external energy source, a simple cost calculation shows that a system employing traditional techniques and so designed as to be able to operate a laptop and simultaneously charge up its accumulator costs about twice as much to manufacture as a system which simply supplies energy to the laptop.

### DESCRIPTION OF THE INVENTION

It is an object of the invention to eliminate the disadvantages discussed above when using alternative external energy sources.

This object is achieved by the connection device of claim 1, the connection interface of claim 6, the electrical consumer with the features of claim 8, and the method according to claim 11. Advantageous further developments and detailed solutions of the invention are disclosed in the subclaims.

The connection device according to the invention for connecting an external energy source to an electrical consumer with an internal energy source comprises an interconnection, which is so designed that an external energy source connected to the connection device exclusively supplies the consumer with energy in a lower load range and in a higher load range supplies the consumer with energy in conjunction with the internal energy source. A connected external energy source forms a hybrid energy source in conjunction with the internal energy source. In contrast to the hybrid modules consisting of a prescribed combination of two (or more) energy sources, known technology, with the present invention a hybridization does not result until an external energy source is connected to the connection device according to the invention.

The position of the transition from the lower load range to the upper load range depends on the characteristics of the energy sources (terminal voltages, internal resistances), and also, particularly, on the charged status of the internal energy source.

If the charged status of the internal energy source is high and/or a still higher mobility is desired, the external energy source can be decoupled and the electrical consumer can be operated with the internal energy source alone. If, on the other hand, no practical restrictions result from connection of an external energy source, the internal energy source can be spared and the operation of the consumer can either be guaranteed exclusively by the external energy source or at least be supported by the external energy source.

The connection device according to the invention is particularly suitable for an electrical consumer whose internal energy source comprises a rechargeable energy source, the interconnection of the connection device being preferably so designed that the rechargeable energy source can be recharged by the external energy source connected to the connection device.

In this further development the rechargeable energy source can be charged up again by the external energy source when the consumer is switched off and in the lower load range of the consumer, so that internal and external energy sources complement each other advantageously:
switched-off consumer:
   external energy source charges internal energy source
switched-on consumer:
   external energy source charges internal energy source and operates consumer or
   external energy source and internal energy source operate consumer.

The connection device is particularly suitable for electrical consumers whose internal rechargeable energy source comprises a capacitor and/or an accumulator. The interconnection of the connection device is preferably so designed that the connected external energy source is connected in parallel with the capacitor and/or the accumulator.

In this case the external energy source and the internal energy source can be connected together without a voltage converter, which is subject to loss, which not only increases the efficiency of the hybridized energy source but also simplifies the design of the connection device.

The most important advantage of a capacitor lies primarily in the support it provides in coping with load peaks, which are produced e.g. by switch-on events.

In a preferred further development at least one connection of the interconnection between the external energy source and the accumulator has two parallel branches. The first branch is provided to enable the accumulator to be charged up by the external energy source and it has a charge limiter to limit the charging, the second branch is provided to enable current to be drained from the accumulator and it has a device to prevent the accumulator being charged up via the second branch.

The charge limiter might comprise a current limiter and/or a voltage limiter. Current can be fed into the accumulator via the charge limiter but cannot be drained from it. The device for preventing the accumulator being charged up via the second branch might comprise a diode, which only permits current to be drained off but not fed in.

In another preferred further development the connection device comprises devices for preventing a short-circuit current through the internal and/or external energy source and/or for preventing a current flowing contrary to the natural current direction of the external energy source.

Short-circuit currents can arise e.g. when the internal resistance collapses due to a defect in one of the two energy sources, which could lead to an uncontrolled increase in the current and irreparable damage to the energy sources. Also, in the case of a fuel cell and a non-rechargeable battery (primary element) currents contrary to the natural current direction can cause their destruction, so that such currents should also be avoided. The devices employed to this end comprise inter alia short-circuit fuses and/or diodes.

As already mentioned at the outset, many electrical consumers with an internal rechargeable energy source (usually an accumulator) have a connection device for supplying energy via the mains voltage by means of which the internal energy source can be charged up via an internal or external charge regulator and the consumer can be operated at the same time, so that the internal energy source does not have to be removed in order to be charged up and the operation of the electrical consumer is not interrupted even briefly during recharging. The connection device according to the invention described above offers the possibility of providing a connection interface comprising two connection devices: a first connection device for hybridizing the internal energy source with an external energy source, and a second (conventional) connection device for charging the internal energy source via a power pack.

As a result the energy to the consumer can be provided optionally by
(i) the internal energy source,
(ii) a mains-independent external energy source alone (lower load range) or
together with the internal energy source (upper load range), or
(iii) the mains.

The connection interface is preferably provided with a switching device which automatically switches to mains operation and deactivates the connection device for the second external energy source, e.g. mechanically blocks or interrupts the lines implementing hybridization with the internal energy source, when a power pack is connected.

In addition a manually operable switch (or similar operating device) can be provided, the operation of which optionally cancels the hybridization between the external energy source and the internal energy source, energy being supplied to the consumer by the external energy source alone, whatever the load may be, when hybridization is cancelled. This is a sensible arrangement when e.g. a rechargeable battery (secondary element) is replaced by a non-rechargeable battery (primary element). Instead of the manually operable switch an automatically controlled switching device can be provided which switches in the hybridization only above a certain energy demand—either predetermined or depending on the characteristics of the external and/or internal energy source—and below this allows the energy to the consumer to be supplied by the external energy source alone.

To prevent confusion between mains-independent and mains-dependent energy supply when connecting external energy sources, in a particularly preferred further development of the connection interface the first and the second connection device are designed differently in such a way as to make it impossible to wrongly connect an external energy source. In particular, accidental connection of the mains supply to the first connection device, which could damage or destroy the internal energy source and or the consumer, is avoided in this way.

The object of the invention is further achieved through the provision of electrical consumers which are equipped with a connection device according to the invention or a connection interface according to the invention.

Each connection device of such an electrical consumer preferably comprises a socket in the wall of the casing of the electrical consumer, thereby providing user-friendly coupling and decoupling of the external energy source(s). Sensibly, the sockets for mains-independent and mains-dependent energy supply are of different design so as to prevent faulty connection. Most importantly, connection of the mains supply to the connection device provided for hybridization should be impossible, which can e.g. be achieved in a simple way by means of a smaller socket diameter.

In the method according to the invention for supplying energy to an electrical consumer with an internal energy source the internal energy source is so hybridized with an external energy source that the external energy source
exclusively supplies the consumer with energy in a lower load range and
in an upper load range supplies the consumer with energy in conjunction with the internal energy source.

In conventional hybrid concepts the hybrid energy source of the consumer is provided either externally or internally. The present invention offers an advantageous alternative to these two extremes. The consumer can, if necessary, be operated without an external energy source, and it can be designed to be much more compact than if a hybrid energy source had to be housed internally. The method according to the invention can be applied to many conventional consumers without the need for any major constructional changes. The connections or interconnections needed for the hybridization of the external and internal energy sources can be installed or implemented subsequently without difficulty for most consumers.

The hybridization of the external energy source with the internal energy source of the electrical consumer is preferably effected via one of the connection devices according to the invention described above. In this case the hybridization can be achieved and cancelled by e.g. simply plugging in and unplugging the external energy source.

Although the invention is suitable for all types of electrical consumers which are equipped with or can be retrofitted with an internal energy source, it is particularly advantageous for a portable computer: the uninterrupted mains-independent operational time, which without the invention is limited by the capacity of the accumulator, can with the invention be extended to practically “infinite”.

The present invention is described below in the light of a preferred embodiment making reference to the enclosed figure.

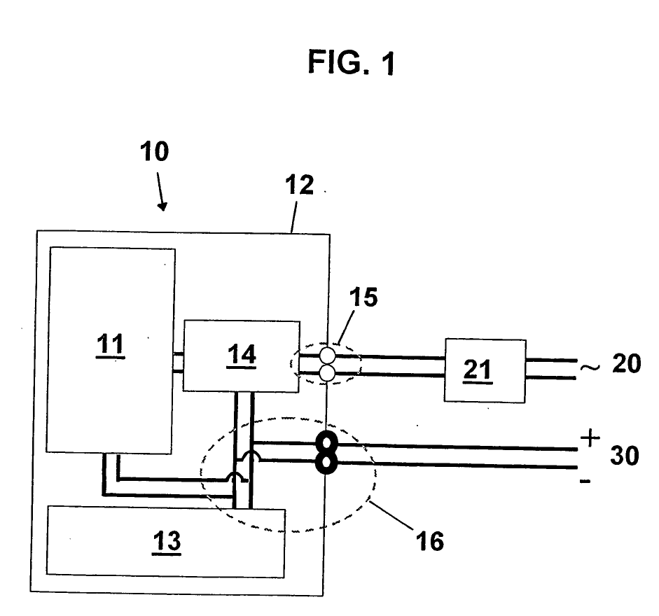

FIG. 1 shows a consumer with a conventional connection device and a connection device according to the invention.

FIG. 1 shows a consumer 10, which can be operated optionally via an integrated accumulator 13, the mains voltage 20 and/or a further external energy source 30. The consumer 10 comprises a casing 12, which houses one or more current-consuming components 11 and a rechargeable accumulator 13 for supplying current to the components 11. Also provided is a charge regulator 14, which allows the components 11 to be operated via the mains voltage 20 and the accumulator 13 to be charged up at the same time. This is accomplished by means of a connection device 15, which comprises a socket in the wall of the casing of the consumer 10, via which a power pack 21 can be connected to the charge regulator 14.

In addition to the connection device 15 a further connection device 16 is provided which enables an external energy source 30 to be connected to a further socket and thus to hybridize directly with the accumulator 13. In the present case, which is preferred when the external energy source 30 and the charged accumulator 13 have approximately the same nominal voltage, the external energy source 30 and the accumulator 13 are connected together in parallel in a homopolar arrangement and without further electronic components.

A preferred field of application of the invention is that of portable computers (laptops). With the preferred embodiment described above the battery of a laptop is hybridized with an external fuel cell system, which is plugged into the connection device provided therefore via a cable, in a parallel arrangement (“hard coupling”). Other external energy sources, in particular solar modules, can be connected instead of the fuel cell system. Furthermore, devices can be provided by means of which the laptop recognizes whether it is being supplied by a power pack, by the internal battery alone, or by a hybrid energy source of external energy source and internal battery. Depending on the nature of the energy supply, certain power management parameters can be optimized according to the particular operating mode, e.g. processor speed. Furthermore, devices can be provided which automatically switch the operating mode of the laptop to power pack operation when a power pack is connected.

The mains-independent external energy source can, in principle, also be implemented as a hybrid energy source with an accumulator. Since, however, nearly all the available laptops (as also many other consumers) have their own internal accumulator, which, for various reasons, is to remain in the laptop even when the laptop is operated with an external energy source—e.g. because the accumulator is part of the casing, because the user is used to this mode of handling, for increasing the service reliability, etc.—it is expedient to use this internal accumulator to implement the hybrid energy source. In this case cost, weight and space savings can be achieved compared with conventional hybrid energy sources, where an energy source such as a fuel cell system is combined with an external battery. This is especially true today since the (internal) batteries used nowadays are extremely efficient.

In the connection interface according to the invention an additional connection for an external energy source (e.g. fuel cell) is provided which is directly connected electrically to the connection of the internal accumulator. It should be noted here that the usual connection for the external power pack is not suitable for this since it is not connected to the accumulator directly but only indirectly via an electronic circuit (charge regulator). A consequence of this is that e.g. the charging of a laptop accumulator with a nominal voltage of about 12 V requires a voltage about 50% higher (approx. 18 V).

The electrical interconnection of external energy source and internal accumulator is preferably implemented by direct coupling, i.e. without a voltage converter, as described e.g. in the European Patent Application with the serial number 02013266.8. In this case the voltages of the external energy source and the accumulator at the design point are the same or nearly so—in contrast to the prior art according to which an external energy source always has a markedly higher voltage than the accumulator.

Even if the external energy source itself is equipped as a hybrid energy source with its own accumulator, this external energy source accumulator can, because of the additional hybridization with the internal energy source of the consumer, be substantially reduced in size, which also results in a cost saving.

The additional socket for the mains-independent external energy source is preferably so implemented that its type or size (or both) precludes any risk of confusion with the socket for the power pack. For special external energy sources this additional socket is e.g. labelled “Fuel/Solar cell” and is directly connected to the battery. A short-circuit fuse is incorporated in this connection which e.g. prevents the accumulator being short-circuited in the event of a faulty external fuel cell system or cable. A simple load regulator can also be installed in the external energy source, e.g. the fuel cell system.

Some of the most important advantages of the present invention are summarized again below:
Cost, weight and volume savings because tailored dimensioning of fuel cell systems or solar modules, etc. becomes possible and these external energy sources require either no accumulator of their own or at most a very small-dimensioned one.
A large degree of flexibility and compatibility—free choice between power pack operation, battery operation, fuel cell operation, as well as “hot-swap” capability (changeover in uninterrupted operation).
Removal of obstacles to the marketing of fuel cell/solar systems.
Adding to the spectrum of applications for portable electronic/electrical devices.
Advantages of (1) fuel cell systems or (2) solar modules, e.g. (1) longer operation times, almost instantaneous exchange of tank cartridges, weight saving, etc., (2) environmentally clean provision of energy, autarchy, etc.

It is not necessary to refer specifically to numerous additional advantages of the invention since they will be apparent to the person skilled in the art. In conclusion it is emphasized once again that the examples which have just been cited serve only to help in understanding the invention. The scope of the invention itself, on the other hand, is defined exclusively by the following claims.

1. Connection device for an electrical consumer with an internal energy source, for connecting an external energy source, such that:
the connection device comprises an interconnection which is designed in such a way that an external energy source connected to the connection device
exclusively supplies the consumer with energy in a lower load range and
in a higher load range supplies the consumer with energy in conjunction with the internal energy source.

2. Connection device according to claim 1 for an electrical consumer whose internal energy source comprises a rechargeable energy source, such that:
the interconnection of the connection device is also so designed that the rechargeable energy source can be recharged by the external energy source which is connected to the connection device.

3. Connection device according to claim 2 for an electrical consumer whose internal rechargeable energy source comprises a capacitor and/or an accumulator, such that:
the interconnection of the connection device is so designed that the connected external energy source is connected in parallel with the capacitor and/or the accumulator.

4. Connection device according to claim 3, wherein at least one connection of the interconnection between the external energy source and the accumulator has two parallel branches, such that:
the first branch is provided to enable the accumulator to be charged up by the external energy source and it has a charge limiter to limit the charging, and
the second branch is provided to enable current to be drained from the accumulator and it has a device to prevent the accumulator being charged up via the second branch.

5. Connection device according to claim 1, with devices for preventing a short-circuit current through the internal and/or external energy source and/or for preventing a current flowing contrary to the natural current direction of the external energy source.

6. Connection interface for an electrical consumer with an internal rechargeable energy source, comprising:
a first connection device which is designed according to claim 1,
a second connection device which is designed for charging the internal rechargeable energy source via a power pack.

7. Connection interface according to claim 6, wherein the first and the second connection device are designed differently in such a way as to make it impossible to wrongly connect an external energy source.

8. Electrical consumer with one of
a connection device according to claim 1, and
a connection interface for an electrical consumer with an internal rechargeable energy source, comprising a first connection device which is designed according to claim 1 and a second connection device which is designed for charging the internal rechargeable energy source via a power pack.

9. Electrical consumer according to claim 8, wherein the connection devices comprise sockets in the wall of the casing of the electrical consumer.

10. Electrical consumer according to claim 9 which comprises a portable computer.

11. Method for supplying energy to an electrical consumer with an internal energy source, wherein the internal energy source is so hybridized with an external energy source that the external energy source
exclusively supplies the consumer with energy in a lower load range and
in a higher load range supplies the consumer with energy in conjunction with the internal energy source.

12. Method, for supplying energy to an electrical consumer with an internal energy source, wherein the internal energy source is so hybridized with an external energy source that the external energy source
exclusively supplies the consumer with energy in a lower load range and
in a higher load range supplies the consumer with energy in conjunction with the internal energy source,
wherein the hybridization of the external energy source with the internal energy source of the electrical consumer is effected via a connection device according to claim 1.

13. Electrical consumer according to claim 8, wherein the first and the second connection device are designed differently in such a way as to make it impossible to wrongly connect an external energy source.

14. Connection device according to claim 2, with devices for preventing a short-circuit current through the internal and/or external energy source and/or for preventing a current flowing contrary to the natural current direction of the external energy source.

15. Connection device according to claim 4, with devices for preventing a short-circuit current through the internal and/or external energy source and/or for preventing a current flowing contrary to the natural current direction of the external energy source.

16. Connection interface for an electrical consumer with an internal rechargeable energy source, comprising:
a first connection device which is designed according to claim 2,
a second connection device which is designed for charging the internal rechargeable energy source via a power pack.

17. Connection interface for an electrical consumer with an internal rechargeable energy source, comprising:
a first connection device which is designed according to claim 4,
a second connection device which is designed for charging the internal rechargeable energy source via a power pack.

18. Connection interface for an electrical consumer with an internal rechargeable energy source, comprising:
a first connection device which is designed according to claim 5,
a second connection device which is designed for charging the internal rechargeable energy source via a power pack.

19. Method, for supplying energy to an electrical consumer with an internal energy source, wherein the internal energy source is so hybridized with an external energy source that the external energy source
exclusively supplies the consumer with energy in a lower load range and
in a higher load range supplies the consumer with energy in conjunction with the internal energy source,
wherein the hybridization of the external energy source with the internal energy source of the electrical consumer is effected via a connection device according to claim 2.

20. Method, for supplying energy to an electrical consumer with an internal energy source, wherein the internal energy source is so hybridized with an external energy source that the external energy source
exclusively supplies the consumer with energy in a lower load range and
in a higher load range supplies the consumer with energy in conjunction with the internal energy source,
wherein the hybridization of the external energy source with the internal energy source of the electrical consumer is effected via a connection device according to claim 4.
